(19) United States
(12) Patent Application Publication
(10) Pub. No.: US 2025/0338260 A1
(43) Pub. Date: Oct. 30, 2025

(54) AVAILABILITY INDICATION FOR INTEGRATED ACCESS AND BACKHAUL TIME-DOMAIN AND FREQUENCY-DOMAIN SOFT RESOURCE UTILIZATION

(71) Applicant: Telefonaktiebolaget LM Ericsson (PUBL), Stockholm (SE)

(72) Inventors: Boris DORTSCHY, Vendelsö (SE); Magnus ÅSTRÖM, Lund (SE); Lei BAO, Göteborg (SE)

(21) Appl. No.: 18/708,731

(22) PCT Filed: Nov. 15, 2022
(86) PCT No.: PCT/EP2022/082001

§ 371 Date: May 9, 2024

Related U.S. Application Data
(60) Provisional application No. 63/280,094, filed on Nov. 16, 2021.

(51) Int. Cl. H04W 72/0446; H04W 72/0453

(52) U.S. Cl. CPC H04W 72/0446; H04W 72/0453

(57) ABSTRACT

A method (1100) by a parent LAB node (55) includes transmitting (1102), to an IAB node (60), information indicating an Al for a TDM resource configuration for an LAB-DU cell associated with the LAB node. The parent LAB node also transmits, to the LAB node, information indicating an AI for a FDM resource configuration for the LAB-DU cell.

### TECHNICAL FIELD

The present disclosure relates, in general, to wireless communications and, more particularly, systems and methods for providing availability indication for Integrated Access and Backhaul (IAB) time-domain multiplexing and frequency-domain multiplexing soft resource utilization.

### BACKGROUND

Densification via the deployment of increasing macro and/or micro base stations is one of the mechanisms that can be employed to satisfy the ever-increasing demand for more and more bandwidth/capacity in mobile networks. Due to the availability of more spectrum in the millimeter wave (mmW) band, deploying small cells that operate in this band is an attractive deployment option for these purposes. However, deploying fiber to the small cells, which is the usual way in which small cells are deployed, can end up being very expensive and impractical. Thus, employing a wireless link for connecting the small cells to the operator's network is a cheaper and more practical alternative with increased flexibility and shorter time-to-market. One such solution is an IAB network where the operator can utilize part of the radio resources for the backhaul link.

FIG. 1 illustrates an IAB deployment that supports multiple hops in an IAB network. The IAB donor node, which may also be referred to as an IAB donor, has a wired connection to the core network. The IAB nodes are wirelessly connected using NR to the IAB donor, either directly or indirectly via another IAB node. The connection between IAB donor/node and UEs is called access link, whereas the connection between two IAB nodes or between an IAB donor and an IAB node is called backhaul link. FIG. 2 illustrates IAB terminologies in adjacent hops. As shown in FIG. 2, the adjacent upstream node, which is closer to the IAB donor node of an IAB node, is referred to as a parent IAB node of the IAB node. The adjacent downstream node which is further away from the IAB donor node of an IAB node is referred to as a child node of the IAB node. The backhaul link between the parent IAB node and the IAB node is referred to as a parent (backhaul) link, whereas the backhaul link between the IAB node and the child node is referred to as child (backhaul) link.

### IAB Architecture

As one major difference of the IAB architecture compared to Release 10 (Rel-10) Long Term Evolution (LTE) relay (besides lower layer differences) is that the IAB architecture adopts the Central-Unit (CU)/Distributed-Unit (DU) split of gNodeBs (gNBs) in which time-critical functionalities are realized in the DU closer to the radio and less time-critical functionalities are pooled in the CU with the opportunity for centralization. Based on this architecture, an IAB-donor contains both CU and DU functions. In particular, it contains all CU functions of the IAB-nodes under the same IAB-donor. Each IAB-node then hosts the DU function(s) of a gNB. In order to be able to transmit/receive wireless signals to/from the upstream IAB node or IAB donor, each IAB node has a mobile termination (MT), which is a logical unit providing a necessary set of user equipment-like functions. Via the DU, the IAB node establishes a Radio Link Control (RLC) channel to user equipments (UEs) and/or to MTs of the connected IAB node(s). Via the MT, the IAB-node establishes the backhaul radio interface towards the serving IAB node or IAB donor. FIG. 3 illustrates an IAB architecture for a two-hop chain of IAB nodes under an IAB donor.

Wireless backhaul links are vulnerable to blockage such as, for example, due to moving objects such as vehicles, seasonal changes (foliage), severe weather conditions (rain, snow or hail), or infrastructure changes (new buildings). Such vulnerability also applies to IAB nodes. Also, traffic variations can create uneven load distribution on wireless backhaul links leading to local link or node congestion. In view of those concerns, the IAB topology supports redundant paths as another difference compared to the Rel-10 LTE relay.

FIG. 4 illustrates the following topologies that are considered in IAB:
1. Spanning tree (ST)
2. Directed acyclic graph (DAG)

The arrow indicates the directionality of the graph edge.

It means that one IAB node can have multiple child IAB nodes and/or have multiple parent IAB nodes. The multi-connectivity or route redundancy may be used for back-up purposes. It is also possible that redundant routes are used concurrently such as, for example, to achieve load balancing, reliability, etc.

### Resource Configuration

### Time-Domain Resource Coordination

In case of in-band operation, the IAB node is typically subject to the half-duplex constraint. For example, an IAB node can only be in either transmission or reception mode at a time. Rel-16 IAB mainly consider the time-division multiplexing (TDM) case where the MT and DU resources of the same IAB node are separated in time. Based on this consideration, the following resource types have been defined for IAB MT and DU, respectively.

From an IAB-node MT point-of-view, as in Rel-15, the following time-domain resources can be indicated for the parent link: Downlink (DL) time resource; Uplink (UL) time resource; and Flexible (F) time resource.

From an IAB-node DU point-of-view, the child link has the following types of time resources: DL time resource; UL time resource; F time resource; and Not-available (NA) time resources (resources not to be used for communication on the DU child links).

Each of the downlink, uplink and flexible time-resource types of the DU child link can belong to one of two categories:
Hard (H): The corresponding time resource is always available for the DU child link
Soft(S): The availability of the corresponding time resource for the DU child link is explicitly and/or implicitly controlled by the parent IAB node.

The IAB DU resources are configured per cell, and the H/S/NA attributes for the DU resource configuration are explicitly indicated per-resource type (D/U/F) in each slot. As a result, the semi-static time-domain resources of the DU part can be of seven types in total: Downlink-Hard (DL-H), Downlink-Soft (DL-S), Uplink-Hard (UL-H), Uplink-Soft (UL-S), Flexible-Hard (F-H), Flexible-Soft (F-S), and Not-Available (NA). The coordination relation between MT and DU resources are listed in Table 1.

TABLE 1
Coordination between MT and DU resources of an IAB-node.

| | | MT configuration | | |
|---|---|---|---|---|
| | | DL | UL | Flexible |
| DU | DL-H | DU: can transmit on DL | DU: can transmit on DL | DU: can transmit on DL |
| configuration | | unconditionally; | unconditionally; | unconditionally; |
| | | MT: not available. | MT: not available. | MT: not available. |
| | DL-S | DU: can transmit | DU: can transmit | DU: can transmit |
| | | conditionally; | conditionally; | conditionally; |
| | | MT: available on DL. | MT: available on UL. | MT: available on DL & UL. |
| | UL-H | DU: can schedule UL | DU: can schedule UL | DU: can schedule UL |
| | | unconditionally; | unconditionally; | unconditionally; |
| | | MT: not available. | MT: not available. | MT: not available. |
| | UL-S | DU: can schedule UL | DU: can schedule UL | DU: can schedule UL |
| | | conditionally; | conditionally; | conditionally; |
| | | MT: available on DL. | MT: available on UL. | MT: available on DL & UL. |
| | F-H | DU: can transmit on DL or | DU: can transmit on DL or | DU: can transmit on DL or |
| | | schedule UL | schedule UL | schedule UL |
| | | unconditionally; | unconditionally; | unconditionally; |
| | | MT: not available. | MT: not available. | MT: not available. |
| | F-S | DU: can transmit on DL or | DU: can transmit on DL or | DU: can transmit on DL or |
| | | schedule UL conditionally; | schedule UL conditionally; | schedule UL conditionally; |
| | | MT: available on DL. | MT: available on UL. | MT: available on DL & UL. |
| | NA | DU: not available; | DU: not available; | DU: not available; |
| | | MT: available on DL. | MT: available on UL. | MT: available on DL & UL. |

In Rel-16 IAB there are two ways, for the parent nodes, to indicate the availability of the soft time-domain DU resource: implicit indication and explicit indication. The explicit indication, referred to as Availability Indication (AI), uses Downlink Control Information (DCI) Format 2_5 for dynamically indicating the availability of DU Soft resource in a slot is disclosed in 3GPP TS 38.213 and 3GPP TS 38.331. See, 3GPP TS 38.213 “NR: Physical layer procedures for control (Release 16)”, 3GPP, V16.7.0, September 2021; 3GPP TS 38.331 NR; Radio Resource Control (RRC) protocol specification (Release 16). V16.6.0, September 2021.

FIG. 5 illustrates the signaling design for the DCI format 2_5. For each serving cell, the IAB-DU is provided with a cell identity (cell-ID), information about the location of AI information (position of information) in a DCI 2_5 and a set of availability combinations. Each availability combination contains a sequence (resourceAvailability) of elements indicating the availability of soft symbols in one or more slots for the IAB-DU serving cell and an identity number (availabilityCombinationId) to map between symbol availability combinations provided by resourceAvailability and information provided via DCI 2_5 (the indices in DCI 2_5). The provisioning to the IAB-node of the combination of the cell-ID, location information and the set of availability combinations is by using an RRC information element.

Furthermore, an IAB-DU function may correspond to multiple cells, including cells operating on different carrier frequencies. Similarly, an IAB-MT function may correspond to multiple carrier frequencies. This can either be implemented by one IAB-MT unit operating on multiple carrier frequencies or be implemented by multiple IAB-MT units, each operating on different carrier frequencies. The H/S/NA attributes for the per-cell DU resource configuration should take into account the associated IAB-MT carrier frequency(ies).

FIG. 6 illustrates one example of such DU configuration.

### Frequency-Domain Resource Configuration

One of the objectives in the Rel-17 IAB WID RP-211548 is to have “specification of enhancements to the resource multiplexing between child and parent links of an IAB node, including: support of simultaneous operation (transmission and/or reception) of IAB-node's child and parent links (i.e., MT Tx/DU Tx, MT Tx/DU Rx, MT RN/DU Tx, MT Rx/DU Rx).” See, RP-211548, New WID on Enhancements to Integrated Access and Backhaul, Qualcomm, 3GPP TSG RAN Meeting #92e, June 2021.

One idea for such enhancement is to provide frequency-domain resource configuration. Comparing to the time-domain counterpart, one example of the frequency-domain DU resource configuration is shown in FIG. 7.

### Rel-17 Objective Regarding Coexistence of TDM and FDM Operation Modes

As already mentioned above, in the Rel-17 enhanced IAB WID, the following duplexing enhancements are specified:
Specification of enhancements to the resource multiplexing between child and parent links of an IAB node, including:
   Support of simultaneous operation (transmission and/or reception) of IAB-node's child and parent links (i.e., MT Tx/DU Tx, MT Tx/DU Rx, MT Rx/DU Tx, MT Rx/DU Rx).

The simultaneous operation includes both frequency-division multiplexing (FDM) and spatial-division multiplexing (SDM). To facilitate the coexistence of TDM and FDM operations (i.e., simultaneous IAB-MT TX/IAB-DU TX or IAB-MT RX/IAB-DU RX) in Rel-17 IAB, the following agreements were achieved in RAN1:
Agreement (RAN1 #105)
   For frequency domain multiplexing, H/S/NA configurations for an IAB-node are provided separately in addition to the Rel-16 H/S/NA
Agreement (RAN1 #105)
   DCI Format 2_5 is reused to support soft resource availability indications for frequency-domain resources
   For Future Study (FFS): If additional enhancements are necessary
Agreement (RAN1 #106)

For a given Resource Block (RB) set at a symbol, if Rel-17 frequency domain H/S/NA configuration is not provided, the Rel-16 time domain H/S/NA is applied
Agreement (RAN1 #106)

The semi-static configuration of H/S/NA resource type in frequency domain is provided per RB set, per D/U/F resource type within a slot.
Working Assumption (RAN1 #106bis)
   If both the Rel-16 time domain H/S/NA configuration and Rel-17 frequency domain H/S/NA configuration are provided for a given RB set within a slot, one of the following is selected:
      Alt. 1: An IAB node applies the frequency domain H/S/NA only if the IAB node is currently operating in a non-TDM multiplexing mode in the slot, otherwise the Rel-16 time domain H/S/NA configuration is applied.
   For RAN1 #107-e, companies to consider the following decision point:
   An IAB node (or parent node) cannot operate under a given non-TDM multiplexing mode until:
      Alt. 1: All required conditions and parameters which have been directly indicated/requested to the parent node (e.g. via Medium Access Control-Control Element (MAC-CE)) are explicitly acknowledged by the parent node.
      Alt. 2: All required conditions and parameters which have been directly indicated/requested to the parent node (e.g. via MAC-CE) are implicitly acknowledged by the parent node or implicitly determined at the child node
Agreement (RAN1 #106bis)
   A single DCI format 2_5 can be received indicating availability for the soft resources of the respective RB sets corresponding to a given time resource of the child IAB-DU cell.
      FFS: Extension of AvailabilityCombination to include multiple RB sets in a resource Availabiltiy indication
      FFS: Update resourceAvailability mapping table defined in TS38.213 so that the indication of availability can be applied over soft resources in frequency-domain for DL or UL or Flexible symbols.
      FFS: Need for extension of the maximum payload size of DCI format 2 5 to increase the number of IAB-DU cells that can be provided with availability information for Soft resources to accommodate the maximum number of possible RB sets for a given DU cell (if defined), or other backwards compatible signalling extensions in case the principal indication capabilities of DCI format 2_5 are increased.

There currently exist certain challenge(s), however. For example, as discussed above, in Rel-16 IAB there are two ways, for the parent nodes, to indicate the availability of the soft time-domain DU resource: implicit indication and explicit indication. The explicit indication, referred to as Availability Indication (AI), uses DCI Format 2_5 for dynamically indicating the availability of the IAB-DU soft resource in a slot. It has been agreed in Rel-17 IAB enhancement that configuring frequency-domain H/S/NA is supported to allow for increased resource utilization flexibility, reduced cross-link interference (CLI) and reduced latency.

According to the RANI agreements discussed above, the frequency domain H/S/NA is provided per RB (Resource Block) set, per D/U/F resource type within a slot, and a single DCI format 2_5 can be received to indicate availability of the soft resources of the respective RB sets corresponding to a given time resource of the child IAB-DU cells. One example of possible solution for frequency domain AvailabilityCombination is illustrated in FIG. 8, which provides an example of enhancement for frequency domain resource AI by associating resource Availability to configurable groups of IAB-DU-RB sets by using an identifier referred to as DU-RB-group-ID. The example assumes that the first IAB-DU RB set group (DU-RB-group-ID=0) contains two IAB-DU RB sets (DU-RB-ID=0 and 1); and the second IAB-DU RB set group (DU-RB-group-ID=1) contains three RB sets (DU-RB-ID=2,3,4). One resourceAvailability is provided for each IAB-DU RB set group of a serving cell. The frequency domain resourceAvailability element will have different value (meaning) than the time-domain resourceAvailability element.

As also described above. Rel-17 IAB will support co-existence of TDM and FDM operation modes. One example of how the determination of the TDM or FDM operation could be performed is illustrated in FIG. 9. Namely, when the FDM mode is activated by the parent IAB node, the IAB node will apply the FDM configuration if the FDM configurations is provided. This is shown in Slot ()-Slot 2. Otherwise (e.g, the FDM configuration is not provided), the IAB node should apply the TDM configuration, as shown in Slot 3. The IAB node should apply the TDM configuration when it falls back to TDM, as shown in Slot N.

The current version of 3GPP TS 38.212 provides information on the maximum payload size of DCI Format 2 5, which can be configured by higher layers, as being 128 bits. In fact, the maximum of any DCI size is limited to 140 bits which is restricted due to the specified maximum interleaving size prior to channel encoding, as summarized in Table 5.3.1.1-1 in 3GPP TS 38.212. Since DCI is a scarce resource, there is a need of methods to enable efficient coexistence of time domain and frequency domain DCI format 2_5.

### SUMMARY

Certain aspects of the disclosure and their embodiments may provide solutions to these or other challenges. For example, methods and systems are provided enabling a parent node to efficiently indicate TDM and FDM availability indication using DCI format 2_5. As such, the methods and systems enable coexistence of TDM and FDM operations.

According to certain embodiments, a method by a parent IAB node includes transmitting.

to an IAB node, information indicating an AI for a TDM resource configuration for an IAB-DU cell associated with the IAB node. The parent IAB node also transmits, to the IAB node, information indicating an Al for a FDM resource configuration for the IAB-DU cell.

According to certain embodiments, a parent IAB node includes processing circuitry configured to transmit, to an IAB node, information indicating an AI for a TDM resource configuration for an IAB-DU cell associated with the IAB node. The processing circuitry is also configured to transmit, to the IAB node, information indicating an AI for a FDM resource configuration for the IAB-DU cell.

According to certain embodiments, a method by an IAB node includes receiving, from a parent IAB node, information indicating an AI for a TDM resource configuration for an IAB-DU cell associated with the IAB node. The IAB node also receives, from the parent IAB node, information indicating an AI for a FDM resource configuration for the IAB-DU cell.

According to certain embodiments, an IAB node includes processing circuitry configured to receive, from a parent IAB node, information indicating an Al for a TDM resource configuration for an IAB-DU cell associated with the IAB node. The processing circuitry also receives, from the parent IAB node, information indicating an AI for a FDM resource configuration for the IAB-DU cell.

Certain embodiments may provide one or more of the following technical advantage(s). For example, certain embodiments may provide a technical advantage of enabling the usage of the both soft time-domain resources and soft frequency-domain resources at an IAB-node to provide efficient frequency multiplexing between IAB-MT and collocated IAB-DU. In doing so, the capacity of the IAB node can be greatly increased, in turn resulting in increased network performance, reduced latency and improved user experience.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an IAB deployment that supports multiple hops in an IAB network;

FIG. 2 illustrates IAB terminologies in adjacent hops;

FIG. 3 illustrates an IAB architecture for a two-hop chain of IAB nodes under an IAB donor;

FIG. 4 illustrates certain topologies that are considered in IAB;

FIG. 5 illustrates the signaling design for the DCI format 2_5;

FIG. 6 illustrates an example of a time-domain DU resource configuration;

FIG. 7 illustrates an example of the frequency-domain DU resource configuration;

FIG. 8 illustrates an example of enhancement for frequency domain resource AI by associating resourceAvailability to configurable groups of IAB-DU-RB sets;

FIG. 9 illustrates an example of how a determination of TDM or FDM operation can be performed;

FIG. 10 illustrates an example system for indicating time-domain multiplexing and frequency-domain multiplexing availability indication, according to certain embodiments;

FIG. 11 illustrates an example method for indicating time-domain multiplexing and frequency-domain multiplexing availability indication, according to certain embodiments;

FIG. 12 illustrates an example flow diagram of slot-by-slot availability indication, according to certain embodiments;

FIGS. 13A-13C illustrate separate TDM and FDM resource configurations being provided to the IAB node in separate DCI format 2_5 messages, according to certain embodiments;

FIG. 14 illustrates an example joint DCI format 2_5, according to certain embodiments;

FIG. 15 illustrates an example communication system, according to certain embodiments;

FIG. 16 illustrates an example UE, according to certain embodiments;

FIG. 17 illustrates an example network node, according to certain embodiments;

FIG. 18 illustrates a block diagram of a host, according to certain embodiments;

FIG. 19 illustrates a virtualization environment in which functions implemented by some embodiments may be virtualized, according to certain embodiments;

FIG. 20 illustrates a host communicating via a network node with a UE over a partially wireless connection, according to certain embodiments;

FIG. 21 illustrates a method by a parent IAB node, according to certain embodiments; and

FIG. 22 illustrates a method by an IAB node, according to certain embodiments.

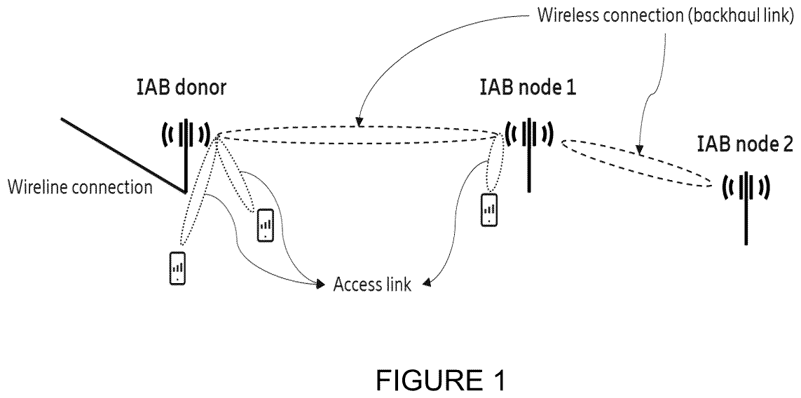

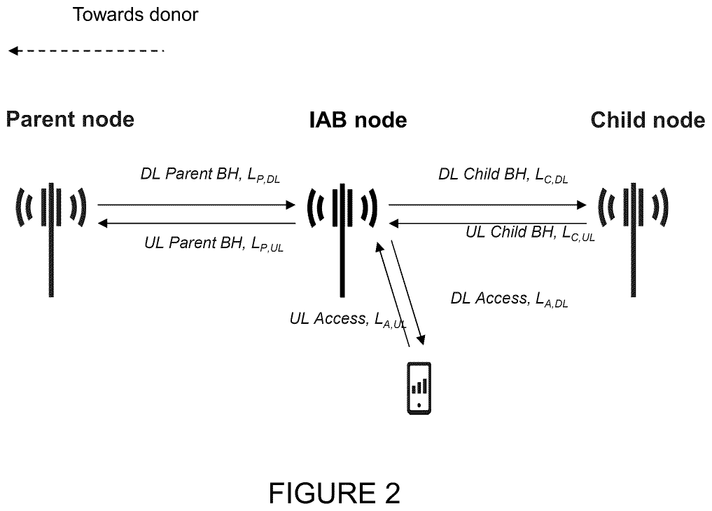

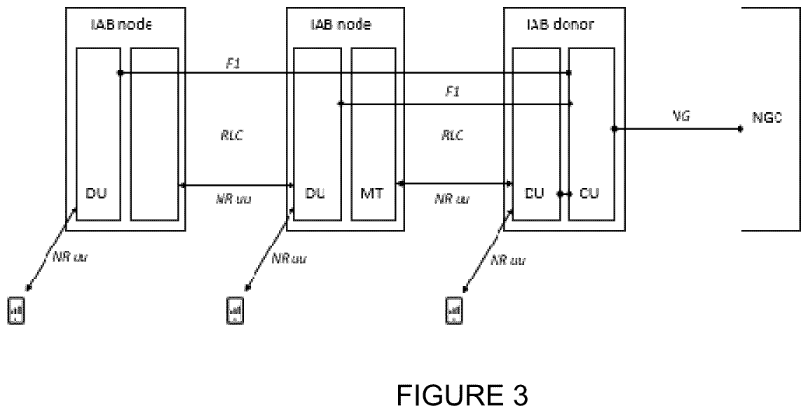

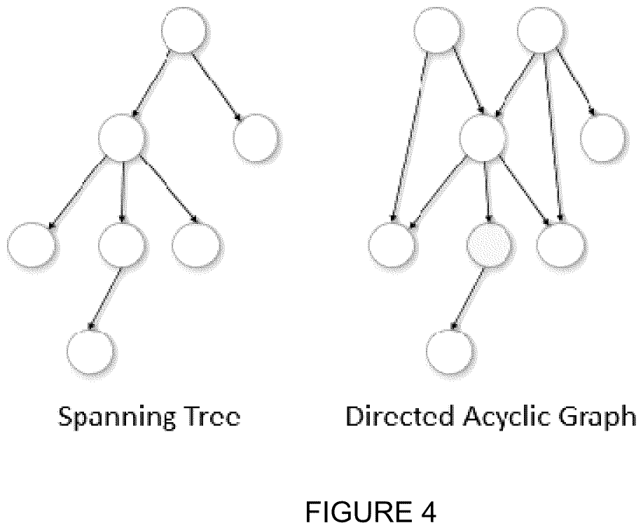

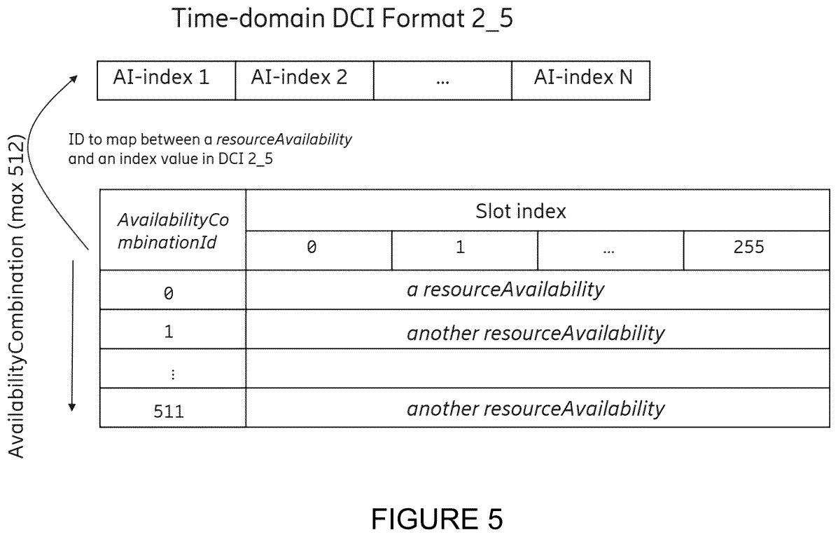

### DETAILED DESCRIPTION

Some of the embodiments contemplated herein will now be described more fully with reference to the accompanying drawings. Embodiments are provided by way of example to convey the scope of the subject matter to those skilled in the art.

According to certain embodiments, the IAB node receives separate DCI format 2_5 from the parent IAB node for time-domain multiplexed and frequency-domain multiplexed resources. The time-domain multiplexing (TDM) DCI format 2_5 is used to indicate AI for TDM soft resources, whilst the frequency-domain multiplexing (FDM) DCI format 2_5 is used to indicate AI for sequential FDM soft resources. At one soft resource slot, either TDM DCI format 2_5, or FDM DCI format 2_5 will be applied.

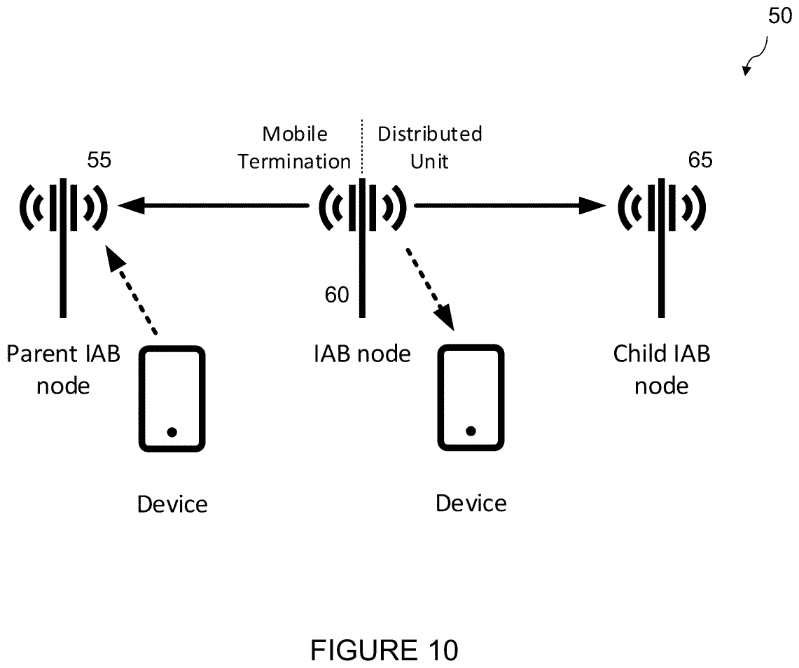

FIG. 10 illustrates an example system 50 for indicating time-domain and frequency-domain availability indication, according to certain embodiments. As illustrated, the system includes an IAB network comprising a parent or donor node 55, an IAB node 60, and possibly also a child node 65. In addition, one or more UEs may be connected to each node, just as one or more child nodes may be connected to an IAB node, and grandchild nodes may be connected to the child nodes.

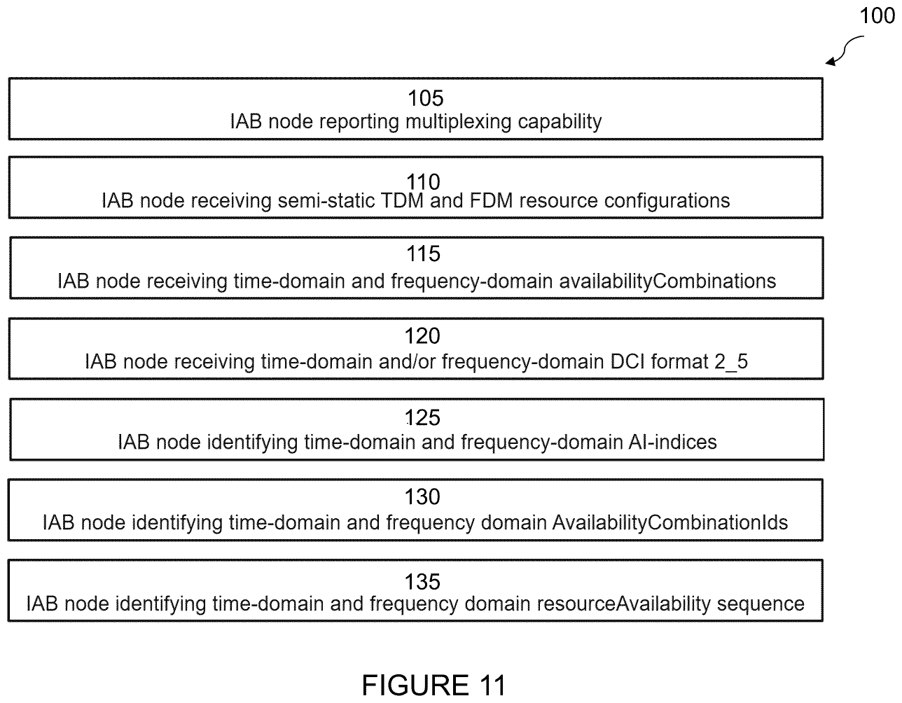

FIG. 11 illustrates an example method 100 for indicating TDM and FDM availability indications, according to certain embodiments.

As illustrated, in a step 105, the IAB node reports the resource multiplexing capability of an IAB-DU cell to the network (e.g., donor-CU), including TDM, and/or FDM, and/or SDM etc. The signaling can be F1 message, in a particular embodiment.

In a step 110, the IAB node receives the semi-static TDM and FDM resource configuration of the said IAB-DU cell from the network (e.g., donor-CU). The signaling can be F1 message, in a particular embodiment.

In a step 115, the IAB node receives, from the network (e.g., donor-CU), a table for TDM resource configuration and a table for FDM resource configuration for the said IAB-DU cell. The signaling can be RRC message, in a particular embodiment.

In a step 120, the IAB node receives a TDM and/or FDM indication of availability from the parent node. In a particular embodiment, the TDM and FDM indication can be via DCI format 2_5 and can be received at different DL slots, since the time-domain and frequency domain DCI format 2 5 will not be used at the same time slot. In one particular embodiment, the IAB-node can monitor for example odd slots for TDM DCI format 2_5 and then even slots for FDM DCI format 2_5, or vice versa. In another particular embodiment, the IAB node can be configured with two AI-RNTIs, i.e., TDM AI-RNTI and FDM AI-RNTI, respectively.

In a step 125, the IAB node identifies the availability for TDM or FDM resources for the said IAB-DU cell.

In a step 130, the IAB node derives the TDM or FDM AvailabilityCombinationIds for the said IAB-DU cell.

In a step 135, the IAB node identifies the corresponding TDM and FDM resourceAvailability sequences based on the TDM or FDM AvailabilityCombinationIds.

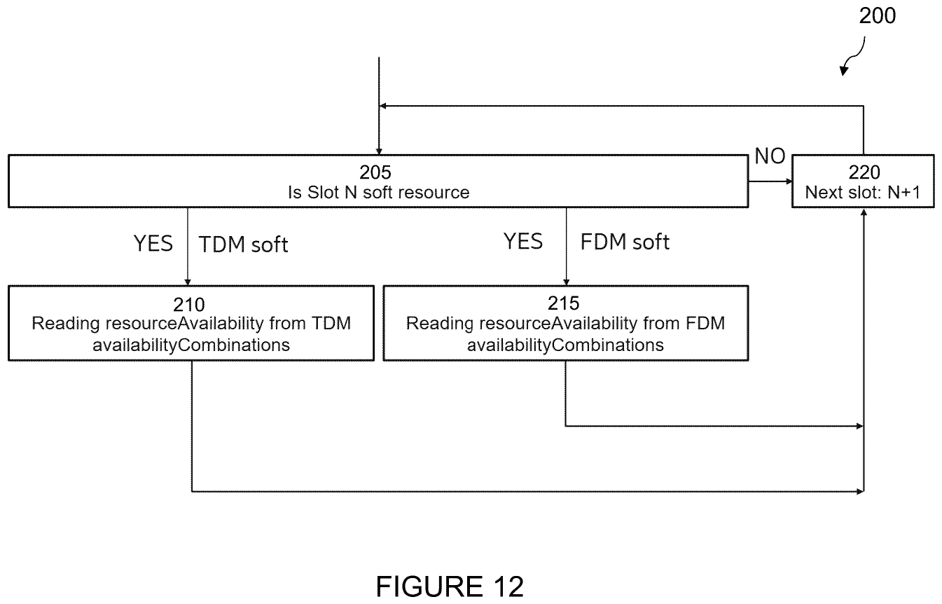

FIG. 12 illustrates an example flow diagram 200 of slot-by-slot availability indication, according to certain embodiments.

As illustrated, in a step 205, the IAB node inspects whether or not Slot N is configured as soft resource.

In a step 210, if the slot is configured as TDM soft resource, the IAB node will read the resourceAvailability value from the TDM resourceAvailablity sequence of the TDM availabilityCombinations.

In a step 215, if the slot is configured as FDM soft resource, the IAB node will read the resourceAvailability value for the relevant RB sets from the FDM resourceAvailability sequence of the FDM availabilityCombinations.

In a step 220, the IAB node will continue to the next slot and repeat the steps of (200)-(202).

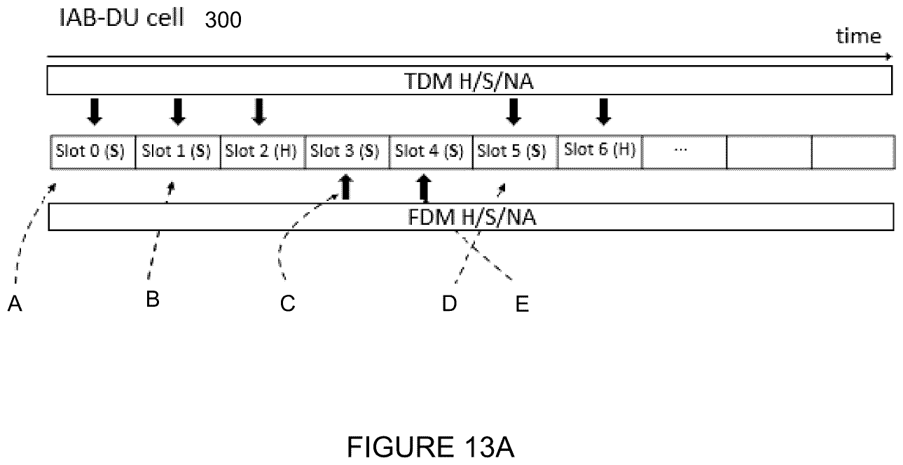

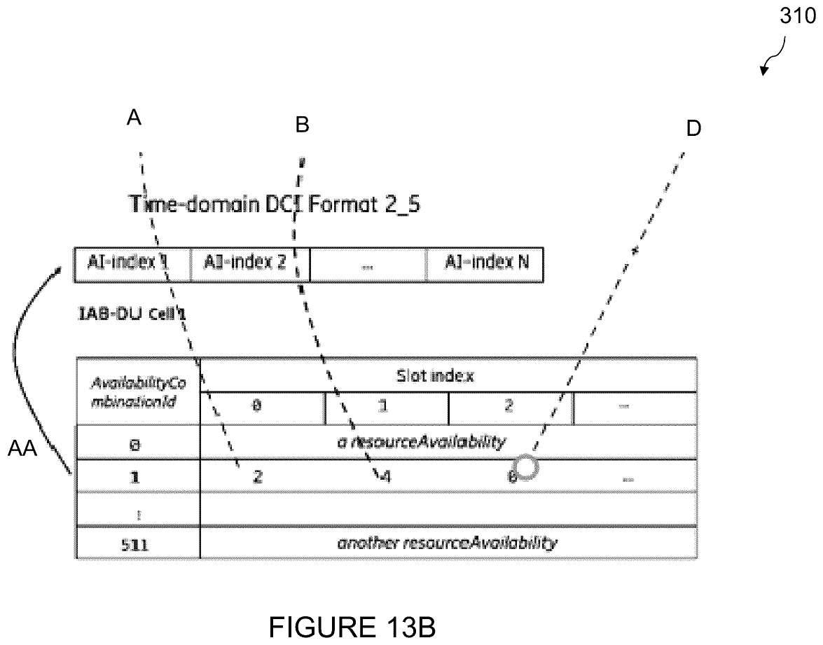

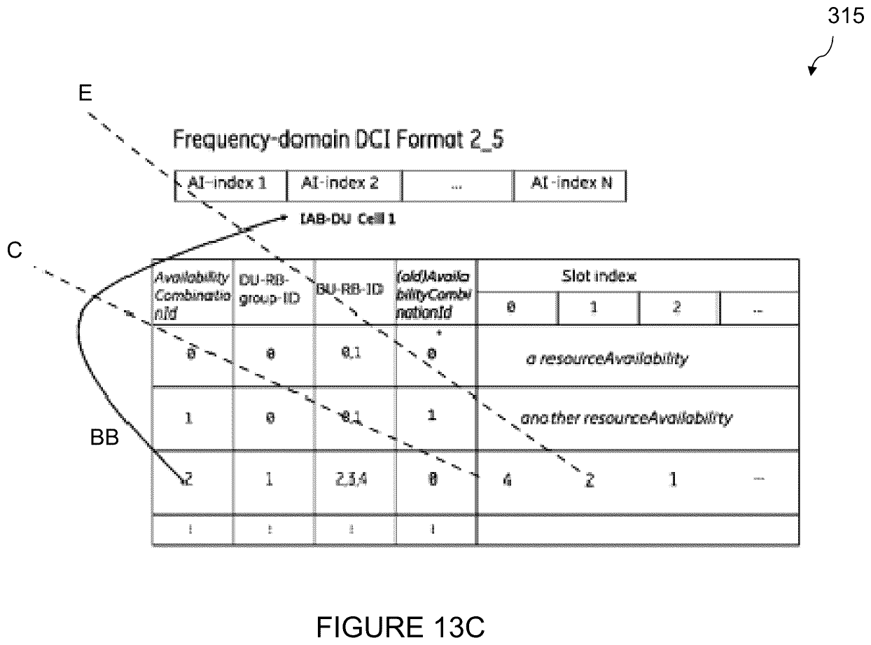

FIGS. 13A-13C illustrate separate TDM and FDM resource configurations being provided to the IAB node in separate DCI format 2_5 messages, according to certain embodiments.

First, the resource configuration of the IAB-DU cell 300 is provided by the donor-CU. The IAB-DU cell 300 includes the following semi-static TDM and FDM resource configurations, which may be provided in as discussed above with regard to step 110 of FIG. 11. As shown in FIG. 13A, the resource configuration of the IAB-DU cell 300 indicates that:
Slot 0, 1, 5 are configured as TDM soft resource
Slot 2, 6 are configured as TDM Hard resource
Slot 3, 4 are configuration as FDM Soft resource

Also, the IAB-node will receive from donor-CU (by RRC message) TDM and FDM AvailabilityIndicators and availabilityCombinationsPerCells information element (IE).

During the operation, and as shown in FIGS. 13B and 13C, respectively, the IAB-DU receives from the parent node two separated DCI format 2_5 messages. Specifically, FIG. 13B illustrates the TDM resource configuration 310 that includes the availability indication of TDM soft resource(s). FIG. 13C illustrates the FDM resource configuration 315 that includes the availability indication of FDM soft resource(s). The two separate DCI format 2_5 messages may be received as described above with respect to step 120 of FIG. 11.

According to step 125 and step 130 of FIG. 11, the IAB-DU identifies that the TDM availability indicator for IAB-DU cell 1 is at TDM DCI format 2_5 position 1, i.e., AI-index 1, as shown by arrow AA in FIG. 13B, and the corresponding AvailabilityCombinationld is 1. Similarly, the IAB-DU identifies the FDM availability indicator for IAB-DU cell 1 is at FDM DCI format 2_5 position 2, i.e., AI-index 2, as shown by arrow BB in FIG. 13C, and the corresponding AvailabilityCombinationld is 2.

According to the step 135 of FIG. 11 and as described above in more detail in FIG. 12, the IAB-node reads from the TDM AvailabilityCombinations table that Slot 0, 1 and 5 are provided with elements of resourceAvailability on positions 0, 1, and 2 of value 2, 4 and 0), respectively, which correspond to arrows A, B, and D, respectively, as illustrated in FIG. 13B; and from the FDM AvailabilityCombinations table that Slot 3 and 4 are provided with elements of resourceAvailability on positions 0, and 1 of value 4 and 2, respectively, which correspond to arrows C and E, respectively, as illustrated in FIG. 13C.

Alternatively, the K-th element of a resourceAvailability (irrespective of TDM or FDM configuration) is mapped to the K-th slot. In one variant, the counting of slots includes slots that are not configured as Soft; in one variant, the counting of slots does not include slots that are not configured as Soft.

### Other Example Scenarios

In a particular embodiment, one shared availabilityCombinations table can be used for AI indication for both TDM and FDM H/S/NA (including multiple RB sets). The TDM resourceAvailablity sequences are considered as special types of FDM resourceAvailability sequences. In one example, the resourceAvailability sequences which are reserved to indicate AI for all configured RB sets of the IAB-DU cell can be used as AI of the TDM soft resource slots. Thereby, the IAB-node only needs to monitor one DCI format 2_5.

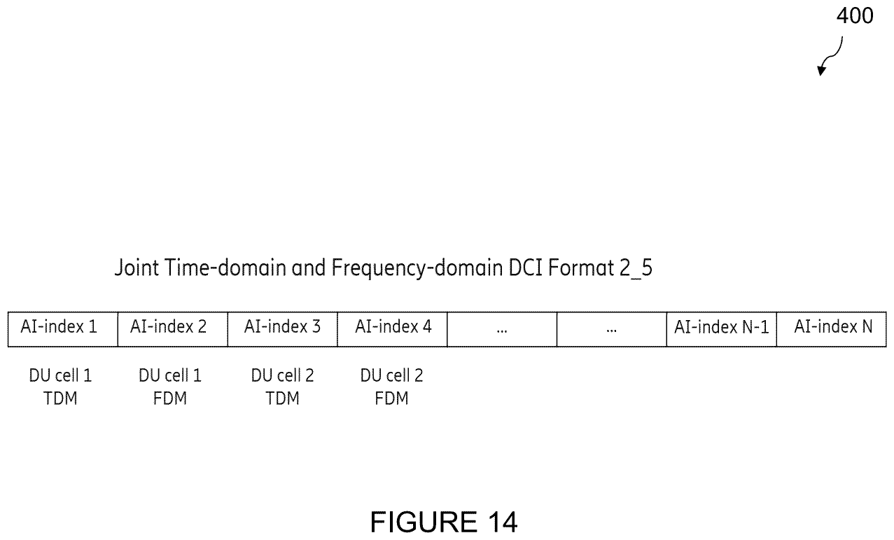

In a particular embodiment, the IAB-node is provided with both TDM and FDM AvailabilityCombinations tables, which will be mapped to one shared DCI format 2_5 from the parent node. FIG. 14 illustrates one DCI format 2_5 message 400 being mapped to both TDM and FDM availabilityCombinations tables, according to certain embodiments. Specifically, as illustrated in FIG. 14, the first position of DCI format 2_5 400 points to the TDM availabilityCombinations table of the IAB-DU cell 1, whilst the second position of DCI format 2_5 points to the FDM availabilityCombinations table of the IAB-DU cell 1. Continuously, the third position of DCI format 2_5 points to the TDM availabilityCombinations table of the IAB-DU cell 2, whilst the fourth position of DCI format 2_5 points to the FDM availabilityCombinations table of the IAB-DU cell 2 etc. The mapping between the DCI format 2_5 and the TFM and FDM availabilityCombinations tables is specified in an RRC message, in a particular embodiment.

In a further particular embodiment, if multiple FDM availabilityCombinations tables are configured (e.g., one for each RB set), each FDM availabilityCombinations table can be mapped to one AI-index.

In a particular embodiment, the time-domain and frequency-domain availabilityCombinations are included in the one AvailabilityIndicator IE and one AvailabilityCombinationsPerCell IE in the RRC message.

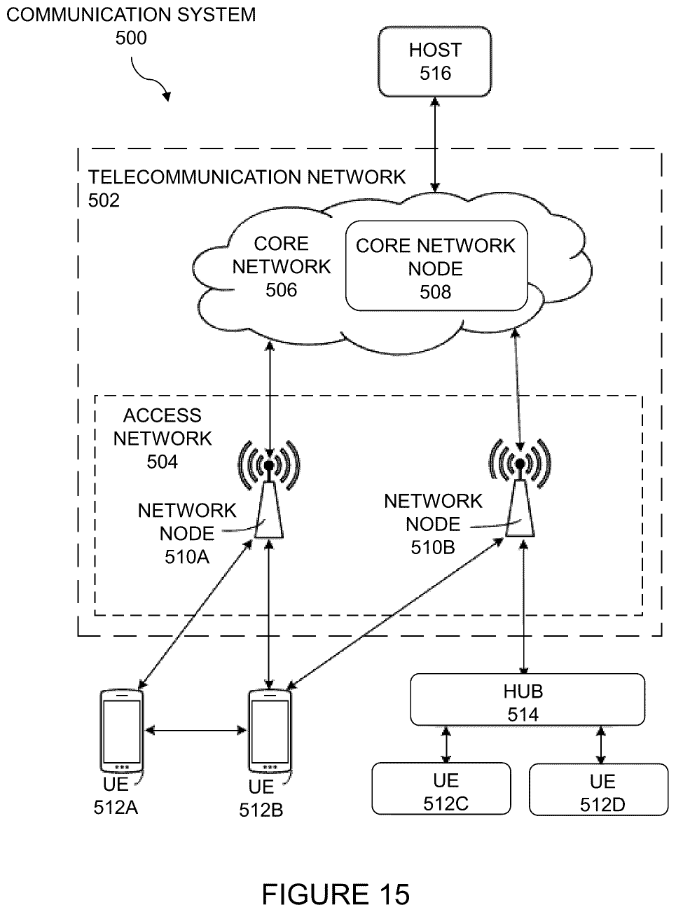

FIG. 15 shows an example of a communication system 500 in accordance with some embodiments. In the example, the communication system 500 includes a telecommunication network 502 that includes an access network 504, such as a radio access network (RAN), and a core network 506, which includes one or more core network nodes 508. The access network 504 includes one or more access network nodes, such as network nodes 510a and 510b (one or more of which may be generally referred to as network nodes 510), or any other similar 3^{rd} Generation Partnership Project (3GPP) access node or non-3GPP access point. The network nodes 510) facilitate direct or indirect connection of user equipment (UE), such as by connecting UEs 512a, 512b, 512c, and 512d (one or more of which may be generally referred to as UEs 512) to the core network 506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 500 may include any number of wired or wireless networks, network nodes, UEs, and/or any other components or systems that may facilitate or participate in the communication of data and/or signals whether via wired or wireless connections. The communication system 500 may include and/or interface with any type of communication, telecommunication, data, cellular, radio network, and/or other similar type of system.

The UEs 512 may be any of a wide variety of communication devices, including wireless devices arranged, configured, and/or operable to communicate wirelessly with the network nodes 510 and other communication devices. Similarly, the network nodes 510 are arranged, capable, configured, and/or operable to communicate directly or indirectly with the UEs 512 and/or with other network nodes or equipment in the telecommunication network 502 to enable and/or provide network access, such as wireless network access, and/or to perform other functions, such as administration in the telecommunication network 502.

In the depicted example, the core network 506 connects the network nodes 510 to one or more hosts, such as host 516. These connections may be direct or indirect via one or more intermediary networks or devices. In other examples, network nodes may be directly coupled to hosts. The core network 506 includes one more core network nodes (e.g., core network node 508) that are structured with hardware and software components. Features of these components may be substantially similar to those described with respect to the UEs, network nodes, and/or hosts. such that the descriptions thereof are generally applicable to the corresponding components of the core network node 508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 516 may be under the ownership or control of a service provider other than an operator or provider of the access network 504 and/or the telecommunication network 502, and may be operated by the service provider or on behalf of the service provider. The host 516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 500 of FIG. 15 enables connectivity between the UEs, network nodes, and hosts. In that sense, the communication system may be configured to operate according to predefined rules or procedures. such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 502 is a cellular network that implements 3GPP standardized features. Accordingly, the telecommunications network 502 may support network slicing to provide different logical networks to different devices that are connected to the telecommunication network 502. For example, the telecommunications network 502 may provide Ultra Reliable Low Latency Communication (URLLC) services to some UEs. while providing Enhanced Mobile Broadband (eMBB) services to other UEs, and/or Massive Machine Type Communication (mMTC)/Massive IoT services to yet further UEs.

In some examples, the UEs 512 are configured to transmit and/or receive information without direct human interaction. For instance, a UE may be designed to transmit information to the access network 504 on a predetermined schedule, when triggered by an internal or external event. or in response to requests from the access network 504. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 514 communicates with the access network 504 to facilitate indirect communication between one or more UEs (e.g., UE 512c and/or 512d) and network nodes (e.g., network node 510b). In some examples, the hub 514 may be a controller, router, content source and analytics, or any of the other communication devices described herein regarding UEs. For example, the hub 514 may be a broadband router enabling access to the core network 506 for the UEs. As another example, the hub 514 may be a controller that sends commands or instructions to one or more actuators in the UEs. Commands or instructions may be received from the UEs, network nodes 510, or by executable code, script, process, or other instructions in the hub 514. As another example, the hub 514 may be a data collector that acts as temporary storage for UE data and, in some embodiments, may perform analysis or other processing of the data. As another example, the hub 514 may be a content source. For example, for a UE that is a VR headset, display, loudspeaker or other media delivery device, the hub 514 may retrieve VR assets, video, audio, or other media or data related to sensory information via a network node, which the hub 514 then provides to the UE either directly, after performing local processing, and/or after adding additional local content. In still another example, the hub 514 acts as a proxy server or orchestrator for the UEs, in particular in if one or more of the UEs are low energy IoT devices.

The hub 514 may have a constant/persistent or intermittent connection to the network node 510b. The hub 514 may also allow for a different communication scheme and/or schedule between the hub 514 and UEs (e.g., UE 512c and/or 512d), and between the hub 514 and the core network 506. In other examples, the hub 514 is connected to the core network 506 and/or one or more UEs via a wired connection. Moreover, the hub 514 may be configured to connect to an M2M service provider over the access network 504 and/or to another UE over a direct connection. In some scenarios. UEs may establish a wireless connection with the network nodes 510 while still connected via the hub 514 via a wired or wireless connection. In some embodiments, the hub 514 may be a dedicated hub-that is, a hub whose primary function is to route communications to/from the UEs from/to the network node 510b. In other embodiments, the hub 514 may be a non-dedicated hub-that is, a device which is capable of operating to route communications between the UEs and network node 510b. but which is additionally capable of operating as a communication start and/or end point for certain data channels.

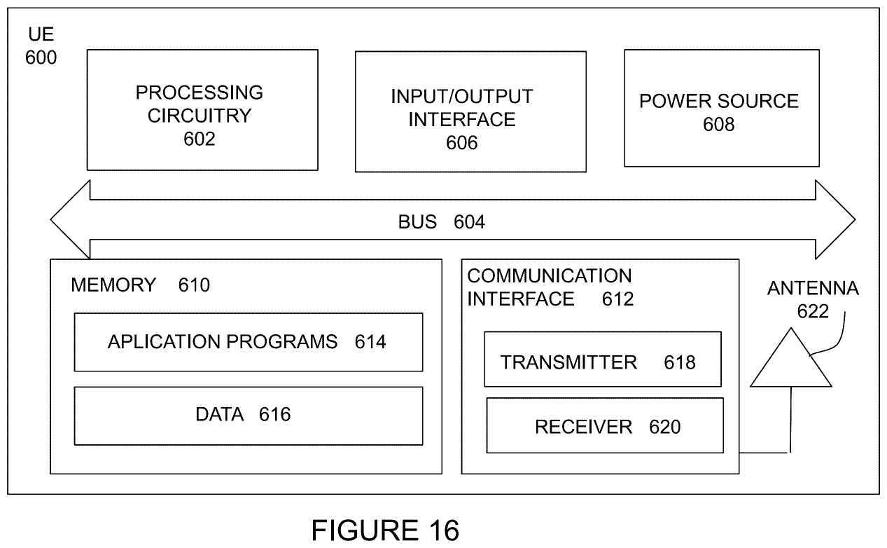

FIG. 16 shows a UE 600 in accordance with some embodiments. As used herein, a UE refers to a device capable, configured, arranged and/or operable to communicate wirelessly with network nodes and/or other UEs. Examples of a UE include, but are not limited to, a smart phone. mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to. or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 600 includes processing circuitry 602 that is operatively coupled via a bus 604 to an input/output interface 606, a power source 608, a memory 610, a communication interface 612, and/or any other component, or any combination thereof. Certain UEs may utilize all or a subset of the components shown in FIG. 16. The level of integration between the components may vary from one UE to another UE. Further, certain UEs may contain multiple instances of a component, such as multiple processors, memories, transceivers, transmitters, receivers, etc.

The processing circuitry 602 is configured to process instructions and data and may be configured to implement any sequential state machine operative to execute instructions stored as machine-readable computer programs in the memory 610. The processing circuitry 602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 602 may include multiple central processing units (CPUs).

In the example, the input/output interface 606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 608 is structured as a battery or battery pack. Other types of power sources, such as an external power source (e.g., an electricity outlet), photovoltaic device, or power cell, may be used. The power source 608 may further include power circuitry for delivering power from the power source 608 itself, and/or an external power source, to the various parts of the UE 600 via input circuitry or an interface such as an electrical power cable. Delivering power may be, for example, for charging of the power source 608. Power circuitry may perform any formatting, converting, or other modification to the power from the power source 608 to make the power suitable for the respective components of the UE 600 to which power is supplied.

The memory 610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 610 includes one or more application programs 614, such as an operating system, web browser application, a widget, gadget engine, or other application, and corresponding data 616. The memory 610 may store, for use by the UE 600, any of a variety of various operating systems or combinations of operating systems.

The memory 610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 610 may allow the UE 600 to access instructions, application programs and the like, stored on transitory or non-transitory memory media, to off-load data, or to upload data. An article of manufacture, such as one utilizing a communication system may be tangibly embodied as or in the memory 610, which may be or comprise a device-readable storage medium.

The processing circuitry 602 may be configured to communicate with an access network or other network using the communication interface 612. The communication interface 612 may comprise one or more communication subsystems and may include or be communicatively coupled to an antenna 622. The communication interface 612 may include one or more transceivers used to communicate, such as by communicating with one or more remote transceivers of another device capable of wireless communication (e.g., another UE or a network node in an access network). Each transceiver may include a transmitter 618 and/or a receiver 620 appropriate to provide network communications (e.g., optical, electrical, frequency allocations, and so forth). Moreover, the transmitter 618 and receiver 620 may be coupled to one or more antennas (e.g., antenna 622) and may share circuit components, software or firmware, or alternatively be implemented separately.

In the illustrated embodiment, communication functions of the communication interface 612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 600 shown in FIG. 16.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

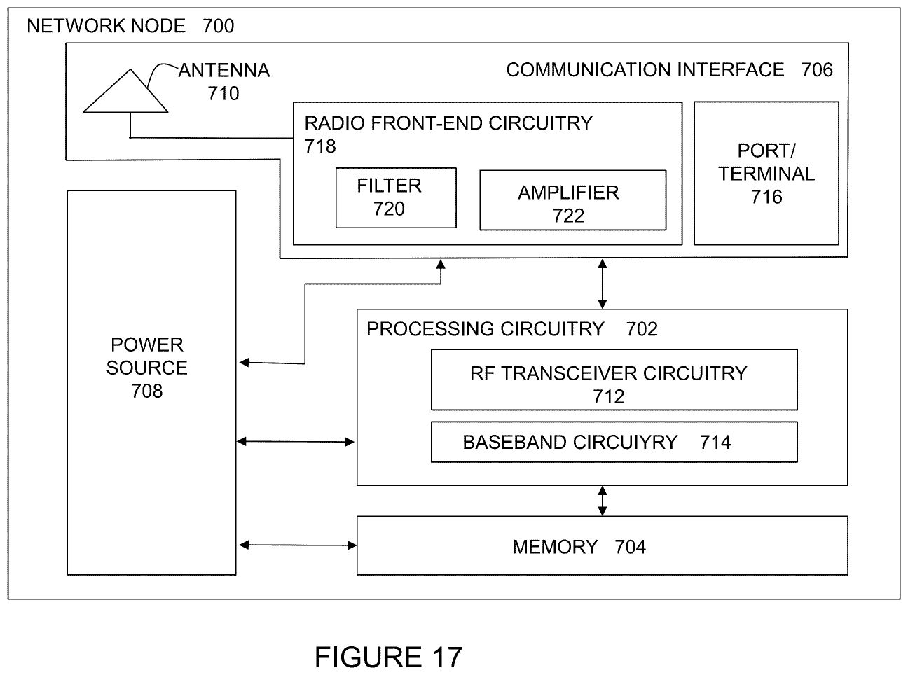

FIG. 17 shows a network node 700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 700 includes a processing circuitry 702, a memory 704, a communication interface 706, and a power source 708. The network node 700 may be composed of multiple physically separate components (e.g., a NodeB component and a RNC component, or a BTS component and a BSC component, etc.), which may each have their own respective components. In certain scenarios in which the network node 700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 700 may be configured to support multiple radio access technologies (RATs). In such embodiments, some components may be duplicated (e.g., separate memory 704 for different RATs) and some components may be reused (e.g., a same antenna 710) may be shared by different RATs). The network node 700 may also include multiple sets of the various illustrated components for different wireless technologies integrated into network node 700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 700.

The processing circuitry 702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 700 components, such as the memory 704, to provide network node 700 functionality.

In some embodiments, the processing circuitry 702 includes a system on a chip (SOC). In some embodiments, the processing circuitry 702 includes one or more of radio frequency (RF) transceiver circuitry 712 and baseband processing circuitry 714. In some embodiments, the radio frequency (RF) transceiver circuitry 712 and the baseband processing circuitry 714 may be on separate chips (or sets of chips), boards, or units, such as radio units and digital units. In alternative embodiments, part or all of RF transceiver circuitry 712 and baseband processing circuitry 714 may be on the same chip or set of chips, boards, or units.

The memory 704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 702. The memory 704 may store any suitable instructions, data, or information, including a computer program, software, an application including one or more of logic, rules, code, tables, and/or other instructions capable of being executed by the processing circuitry 702 and utilized by the network node 700. The memory 704 may be used to store any calculations made by the processing circuitry 702 and/or any data received via the communication interface 706. In some embodiments, the processing circuitry 702 and memory 704 is integrated.

The communication interface 706 is used in wired or wireless communication of signaling and/or data between a network node, access network, and/or UE. As illustrated, the communication interface 706 comprises port(s)/terminal(s) 716 to send and receive data, for example to and from a network over a wired connection. The communication interface 706 also includes radio front-end circuitry 718 that may be coupled to, or in certain embodiments a part of, the antenna 710. Radio front-end circuitry 718 comprises filters 720 and amplifiers 722. The radio front-end circuitry 718 may be connected to an antenna 710 and processing circuitry 702. The radio front-end circuitry may be configured to condition signals communicated between antenna 710 and processing circuitry 702. The radio front-end circuitry 718 may receive digital data that is to be sent out to other network nodes or UEs via a wireless connection. The radio front-end circuitry 718 may convert the digital data into a radio signal having the appropriate channel and bandwidth parameters using a combination of filters 720 and/or amplifiers 722. The radio signal may then be transmitted via the antenna 710. Similarly, when receiving data, the antenna 710 may collect radio signals which are then converted into digital data by the radio front-end circuitry 718. The digital data may be passed to the processing circuitry 702. In other embodiments, the communication interface may comprise different components and/or different combinations of components.

In certain alternative embodiments, the network node 700 does not include separate radio front-end circuitry 718, instead, the processing circuitry 702 includes radio front-end circuitry and is connected to the antenna 710. Similarly, in some embodiments, all or some of the RF transceiver circuitry 712 is part of the communication interface 706. In still other embodiments, the communication interface 706 includes one or more ports or terminals 716, the radio front-end circuitry 718, and the RF transceiver circuitry 712, as part of a radio unit (not shown), and the communication interface 706 communicates with the baseband processing circuitry 714, which is part of a digital unit (not shown).

The antenna 710 may include one or more antennas. or antenna arrays, configured to send and/or receive wireless signals. The antenna 710 may be coupled to the radio front-end circuitry 718 and may be any type of antenna capable of transmitting and receiving data and/or signals wirelessly. In certain embodiments, the antenna 710 is separate from the network node 700 and connectable to the network node 700 through an interface or port.

The antenna 710, communication interface 706, and/or the processing circuitry 702 may be configured to perform any receiving operations and/or certain obtaining operations described herein as being performed by the network node. Any information, data and/or signals may be received from a UE, another network node and/or any other network equipment. Similarly, the antenna 710, the communication interface 706, and/or the processing circuitry 702 may be configured to perform any transmitting operations described herein as being performed by the network node. Any information, data and/or signals may be transmitted to a UE, another network node and/or any other network equipment.

The power source 708 provides power to the various components of network node 700 in a form suitable for the respective components (e.g., at a voltage and current level needed for each respective component). The power source 708 may further comprise. or be coupled to, power management circuitry to supply the components of the network node 700 with power for performing the functionality described herein. For example, the network node 700 may be connectable to an external power source (e.g., the power grid, an electricity outlet) via an input circuitry or interface such as an electrical cable, whereby the external power source supplies power to power circuitry of the power source 708. As a further example, the power source 708 may comprise a source of power in the form of a battery or battery pack which is connected to, or integrated in, power circuitry. The battery may provide backup power should the external power source fail.

Embodiments of the network node 700 may include additional components beyond those shown in FIG. 17 for providing certain aspects of the network node's functionality, including any of the functionality described herein and/or any functionality necessary to support the subject matter described herein. For example, the network node 700 may include user interface equipment to allow input of information into the network node 700 and to allow output of information from the network node 700. This may allow a user to perform diagnostic, maintenance, repair, and other administrative functions for the network node 700.

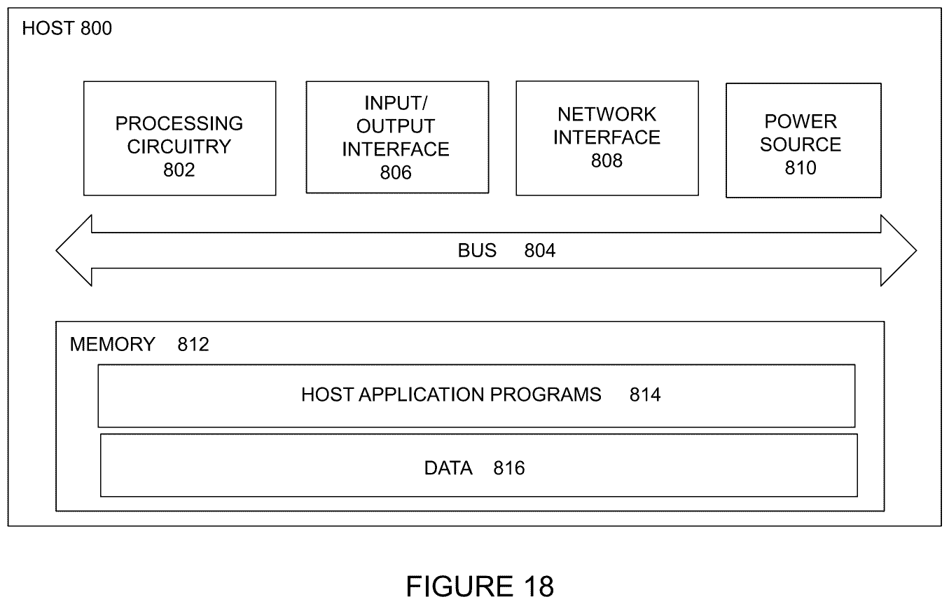

FIG. 18 is a block diagram of a host 800, which may be an embodiment of the host 516 of FIG. 15, in accordance with various aspects described herein. As used herein, the host 800 may be or comprise various combinations hardware and/or software, including a standalone server, a blade server, a cloud-implemented server, a distributed server, a virtual machine, container, or processing resources in a server farm. The host 800 may provide one or more services to one or more UEs.

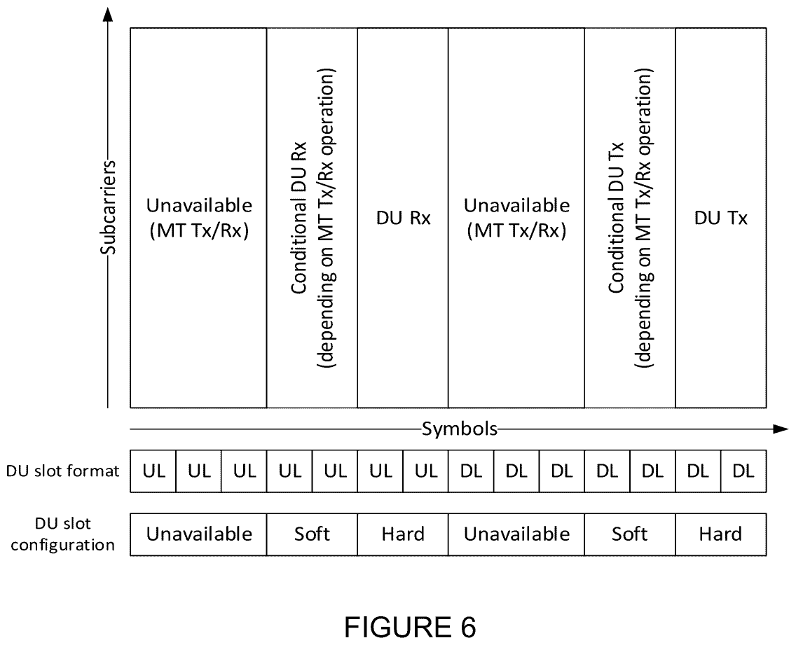

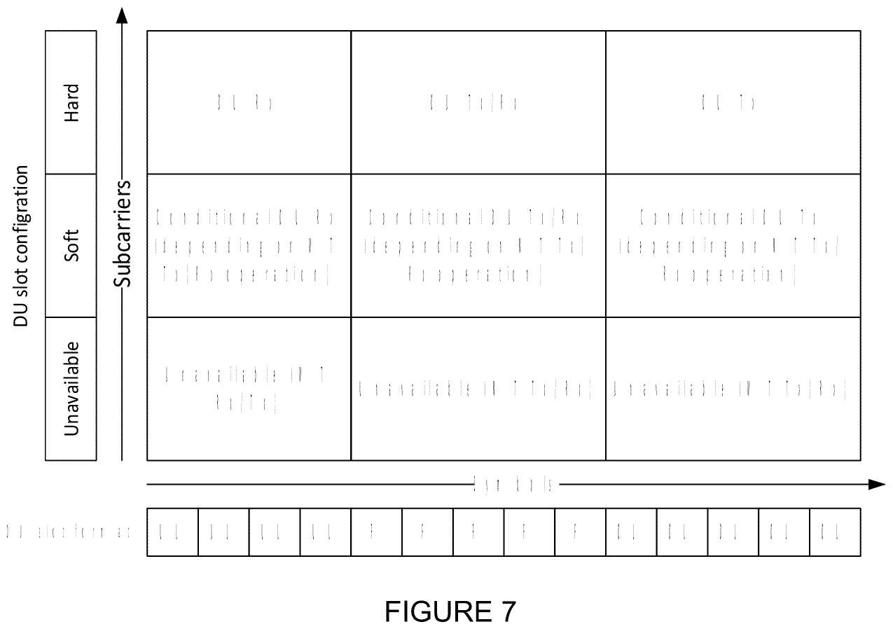

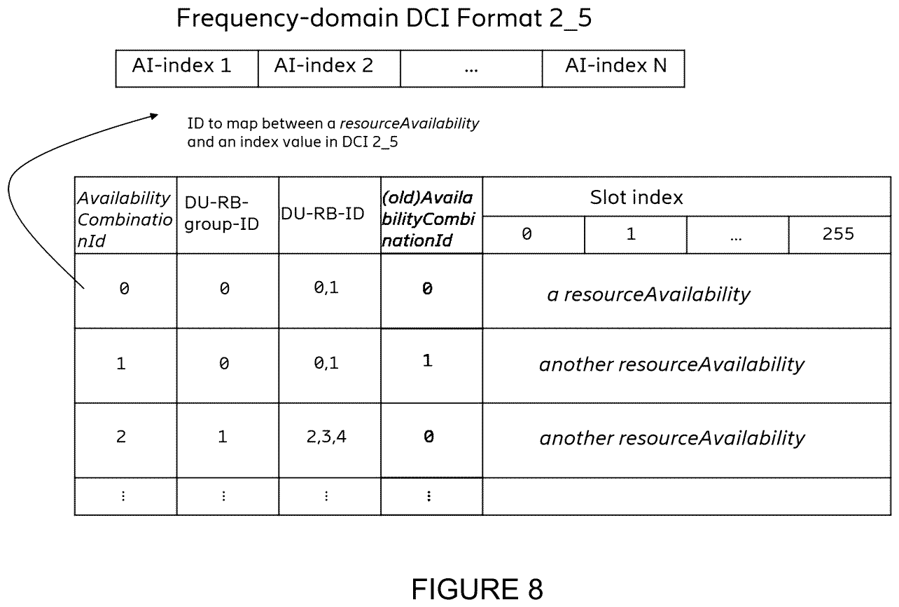

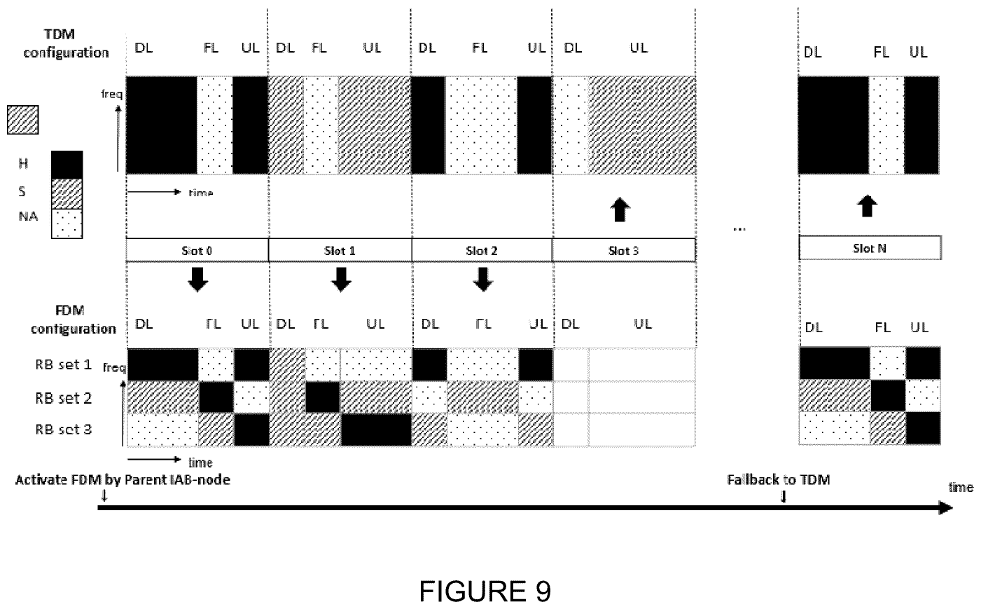

The host 800 includes processing circuitry 802 that is operatively coupled via a bus 804 to an input/output interface 806, a network interface 808, a power source 810, and a memory 812. Other components may be included in other embodiments. Features of these components may be substantially similar to those described with respect to the devices of previous figures, such as FIGS. 6 and 7, such that the descriptions thereof are generally applicable to the corresponding components of host 800.

The memory 812 may include one or more computer programs including one or more host application programs 814 and data 816, which may include user data, e.g., data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 814 may also provide for user authentication and licensing checks and may periodically report health, routes, and content availability to a central node, such as a device in or on the edge of a core network. Accordingly, the host 800 may select and/or indicate a different host for over-the-top services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

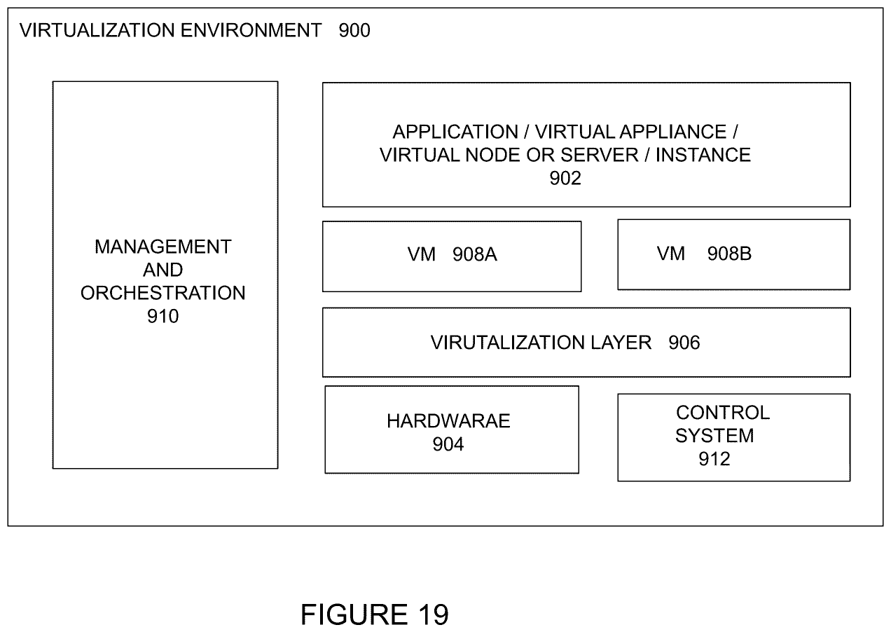

FIG. 19 is a block diagram illustrating a virtualization environment 900 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 912 which may alternatively be used for communication between hardware nodes and radio units.

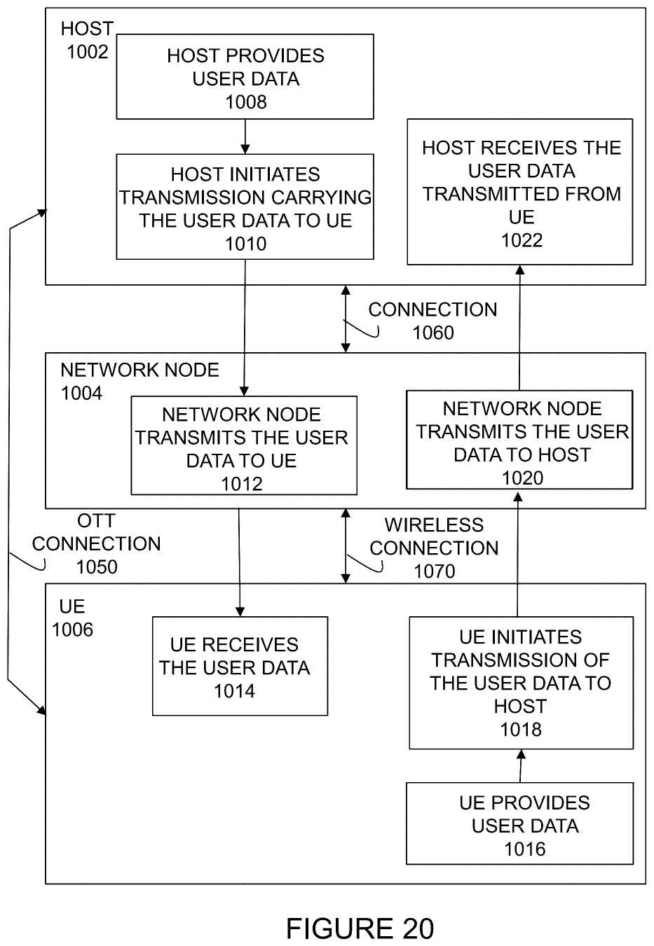

FIG. 20 shows a communication diagram of a host 1002 communicating via a network node 1004 with a UE 1006 over a partially wireless connection in accordance with some embodiments.

Example implementations, in accordance with various embodiments, of the UE (such as a UE 512a of FIG. 15 and/or UE 600 of FIG. 16), network node (such as network node 510a of FIG. 15 and/or network node 700 of FIG. 17), and host (such as host 516 of FIG. 15 and/or host 800 of FIG. 18) discussed in the preceding paragraphs will now be described with reference to FIG. 20.

Like host 800, embodiments of host 1002 include hardware, such as a communication interface, processing circuitry, and memory. The host 1002 also includes software, which is stored in or accessible by the host 1002 and executable by the processing circuitry. The software includes a host application that may be operable to provide a service to a remote user, such as the UE 1006 connecting via an over-the-top (OTT) connection 1050 extending between the UE 1006 and host 1002. In providing the service to the remote user, a host application may provide user data which is transmitted using the OTT connection 1050.

The network node 1004 includes hardware enabling it to communicate with the host 1002 and UE 1006. The connection 1060 may be direct or pass through a core network (like core network 506 of FIG. 15) and/or one or more other intermediate networks, such as one or more public, private, or hosted networks. For example, an intermediate network may be a backbone network or the Internet.

The UE 1006 includes hardware and software, which is stored in or accessible by UE 1006 and executable by the UE's processing circuitry. The software includes a client application, such as a web browser or operator-specific “app” that may be operable to provide a service to a human or non-human user via UE 1006 with the support of the host 1002. In the host 1002, an executing host application may communicate with the executing client application via the OTT connection 1050 terminating at the UE 1006 and host 1002. In providing the service to the user, the UE's client application may receive request data from the host's host application and provide user data in response to the request data. The OTT connection 1050 may transfer both the request data and the user data. The UE's client application may interact with the user to generate the user data that it provides to the host application through the OTT connection 1050.

The OTT connection 1050 may extend via a connection 1060 between the host 1002 and the network node 1004 and via a wireless connection 1070 between the network node 1004 and the UE 1006 to provide the connection between the host 1002 and the UE 1006. The connection 1060 and wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004, in accordance with the teachings of the embodiments described throughout this disclosure. Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

One or more of the various embodiments improve the performance of OTT services provided to the UE 1006 using the OTT connection 1050, in which the wireless connection 1070 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion (e.g., controlling traffic lights). As another example, the host 1002 may store surveillance video uploaded by a UE. As another example, the host 1002 may store or control access to media content such as video, audio, VR or AR which it can broadcast, multicast or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1050 between the host 1002 and UE 1006, in response to variations in the measurement results. The measurement procedure and/or the network functionality for reconfiguring the OTT connection may be implemented in software and hardware of the host 1002 and/or UE 1006. In some embodiments, sensors (not shown) may be deployed in or in association with other devices through which the OTT connection 1050 passes; the sensors may participate in the measurement procedure by supplying values of the monitored quantities exemplified above, or supplying values of other physical quantities from which software may compute or estimate the monitored quantities. The reconfiguring of the OTT connection 1050 may include message format. retransmission settings, preferred routing etc.; the reconfiguring need not directly alter the operation of the network node 1004. Such procedures and functionalities may be known and practiced in the art. In certain embodiments, measurements may involve proprietary UE signaling that facilitates measurements of throughput, propagation times, latency and the like, by the host 1002. The measurements may be implemented in that software causes messages to be transmitted, in particular empty or ‘dummy’ messages, using the OTT connection 1050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

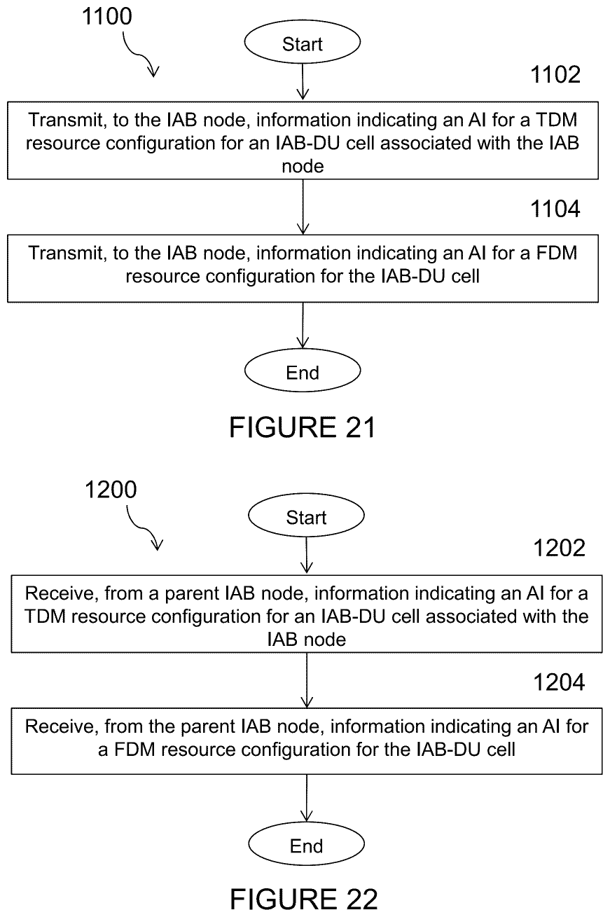

FIG. 21 illustrates a method 1100 by a parent IAB node 55, according to certain embodiments. At step 1102, the method includes the parent IAB node 55 transmitting, to an IAB node 60, information indicating an AI for a TDM resource configuration for an IAB-DU cell associated with the IAB node, at step 1102. At step 1104, the parent IAB node 55 transmits, to the IAB node 60, information indicating an AI for a FDM resource configuration for the IAB-DU cell.

In a particular embodiment, the information indicating the AI for the TDM resource configuration is transmitted in a first message, and the information indicating the AI for the FDM resource configuration is transmitted in a second message.

In a particular embodiment, at least one of the first message and the second message is DCI format 2_5.

In a particular embodiment, the first message is received in a first downlink slot and the second message is received in a second downlink slot.

In a particular embodiment, the information indicating the AI for the TDM resource configuration and the information indicating the AI for the FDM resource configuration is transmitted in a single message.

In a particular embodiment, at least one resource associated with the TDM resource configuration or the FDM resource configuration is a soft resource.

In a particular embodiment, the parent IAB node 55 configures the IAB node 60 to apply the TDM resource configuration or the FDM resource configuration to the at least one resource.

In a particular embodiment, the parent IAB node 55 receives, from the IAB node 60 and/or an IAB donor node, capability information indicating a resource multiplexing capability of the IAB node for the IAB-DU cell.

In a particular embodiment, the parent IAB node 55 transmits, to the IAB node 60, at least one availability Combinations table. For example, the parent IAB node 55 may transmit, to the IAB node 60, a first table that includes at least one TDM availability combination and a second table that includes at least one FDM availability combination for the IAB-DU cell. As another example, the parent IAB node 55 may transmit, to the IAB node 60, a single table that includes both the at least one TDM availability combination and the at least one FDM availability combination.

In a particular embodiment, the parent IAB node 55 configures the IAB node 60 to identify an availability for the TDM resource and/or the FDM resource configuration for the IAB-DU cell.

In a particular embodiment, the parent IAB node 55 configures the IAB node 60 to identify at least one of a TDM AI index and/or a FDM AI index.

In a particular embodiment, the parent IAB node 55 configures the IAB node 60 to identify at least one of a TDM resourceAvailability sequence and/or a FDM resourceAvailability sequence based on a respective one of the TDM AvailabilityCombinationID and the FDM Availability CombinationID.

In a particular embodiment, the parent IAB node 55 configures the IAB node 60 to derive at least one of a TDM Availability CombinationID and/or FDM Availability CombinationID for the IAB-DU cell. For example, the parent IAB node 55 may configure the IAB node 60 to read or decode the first and/or second AI-RNTIs. The content of the AI-RNTI(s) points to a row in the FDM and TDM table(s), in a particular embodiment.

In a particular embodiment, the parent IAB node 55 configures the IAB node 60 to identify a TDM resourceAvailability value and/or a FDM resourceAvailability value. The TDM resourceAvailability value is based on a TDM soft resource and/or the FDM resourceAvailability value is based on a FDM soft resource.

FIG. 22 illustrates a method 1200 by an IAB node 60, according to certain embodiments. At step 1202, the method includes the IAB node receiving, from a parent IAB node 55, information indicating an AI for a TDM resource configuration for an IAB-DU cell associated with the IAB node. At step 1204, the IAB node 60 receives, from the parent IAB node 55, information indicating an AI for a FDM resource configuration for the IAB-DU cell.

In a particular embodiment, the information indicating the AI for the TDM resource configuration is received in a first message, and the information indicating the AI for the FDM resource configuration is received in a second message. In a particular embodiment, at least one of the first message and the second message are DCI format 2_5.

In a particular embodiment, the first message is received in a first downlink slot and the second message is received in a second downlink slot.

In a particular embodiment, the IAB node 60 monitors a first set of slots for the first message and monitoring a second set of slots for the second message.

In a particular embodiment, the information indicating the AI for the TDM resource configuration and the information indicating the AI for the FDM resource configuration is received in a single message.

In a particular embodiment, at least one resource associated with the TDM resource configuration or the FDM resource configuration is a soft resource.

In a particular embodiment, the IAB node 60 applies, at a slot, the TDM resource configuration or the FDM resource configuration to at the at least one resource.

In a particular embodiment, the IAB node 60 receives, from a donor-CU, a resource configuration of the IAB-DU cell, and the resource configuration comprises at least one of the TDM resource configuration and the FDM resource configuration.

In a particular embodiment, the IAB node 60 receives, from the donor-CU, configuration information associated with a sequence of slots, and the configuration information indicates whether each one of the sequence of slots is a hard resource, a soft resource, or a not available resource.

In a particular embodiment, when a particular slot is configured as a TDM soft resource, the IAB node 60 reads a resourceAvailability value from a TDM resourceAvailability sequence of one or more TDM availability combinations. When the particular slot is configured as a FDM soft resource, the IAB node 60 reads a resourceAvailability value from a FDM resourceAvailability sequence of one or more FDM availability combinations.

In a particular embodiment, the IAB node 60 transmits, to the parent IAB node 55, capability information indicating a resource multiplexing capability of the IAB node for the IAB-DU cell.

In a particular embodiment, the IAB node 60 receives, from the parent IAB node 55, at least one availability Combinations table. The at least one availability Combinations table includes at least one TDM availability combination for the IAB-DU cell and/or at least one FDM availability combination for the IAB-DU cell.

In a particular embodiment, the AI for the TDM resource configuration comprises a first AI-RNTI and the AI for the FDM resource configuration comprises a second AI-RNTI.

In a particular embodiment, the IAB node 60 identifies an availability for the TDM resource configuration and/or the FDM resource configuration for the IAB-DU cell.

In a particular embodiment, the IAB node 60 derives at least one of a TDM Availability CombinationID and/or FDM Availability CombinationID for the IAB-DU cell.

In a particular embodiment, the IAB node 60 identifies at least one of a TDM resourceAvailability sequence and/or a FDM resourceAvailability sequence based on a respective one of the TDM Availability CombinationID and the FDM Availability CombinationID.

In a particular embodiment, the IAB node 60 identifies at least one of a TDM AI index and/or a FDM AI index.

In a particular embodiment, the IAB node 60 identifies a TDM resourceAvailability value and/or a FDM resourceAvailability value, and the TDM resourceAvailability value and/or the FDM resourceAvailability value is based on FDM soft resource.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C. A method by a network node operating as a parent node with respect to an IAB node, the method comprising: transmitting information indicating an availability indication (AI) for a time-domain resource; and transmitting information indicating an AI for a frequency-domain resource.

Example Emboidment C2a. The method of Example Emboidment C1, wherein the information indicating the AI for the time-resource is transmitted in a first message, and the information indicating the AI for the time-resource is transmitted in a second message.

Example Embodiment C2b. The method of Example Embodiment C2a, wherein at least one of the first message and the second message are DCI format 2_5.

Example Embodiment C2c. The method of any one of Example Embodiments C2a to C2b, wherein the first message and the second message are received at/in different downlink slots.

Example Embodiment C2d. The method of any one of Example Embodiments C2a to C2c, further comprising configuring the IAB node to monitor even slots for the first message and monitoring odd slots for the second message.

Example Embodiment C2e. The method of any one of Example Embodiments C2a to C2c, further comprising configuring the IAB node to monitor odd slots for the first message and monitoring even slots for the second message.

Example Embodiment C3. The method of Example Emboidment C1, wherein the information indicating the AI for the time-resource and the information indicating the AI for the time-resource is transmitted in a single message.

Example Embodiment C4. The method of any one of Example Embodiments C1 to C3, wherein at least one of the time-domain resource and the frequency-domain resource is a soft resource.

Example Embodiment C5a. The method Example Embodiment C4, further comprising configuring the IAB node to apply the time-domain resource and/or the frequency-domain resource.

Example Embodiment C5b. The method of any one of Example Embodiments C4 to C5a, further comprising configuring the IAB node to inspect the slot to determine that the slot is the configured as a soft resource and/or soft resource slot.

Example embodiment C5c. The method of Example Embodiment C5b, further comprising configuring the IAB node to read a resourceAvailability value from a TDM resourceAvailability sequence of one or more TDM availability combinations when the slot is configured as a time- domain soft resource.

Example embodiment C5d. The method of Example Embodiment C5b, further comprising: configuring the IAB node to read a resourceAvailability value from a FDM resourceAvailability sequence of one or more FDM availability combinations when the slot is configured as a frequency-domain soft resource.

Example embodiment C5e. The method of any one of Example Embodiments C5a to C5d, further comprising configuring the IAB node to repeat any of the steps of Example Embodiments C5a to C5d for at least one subsequent slot.

Example Embodiment C6. The method of any one of Example Embodiments C1 to C5, further comprising receiving, from the IAB node, capability information indicating a resource multiplexing capability of IAB-DU cell.

Example Embodiment C7. The method of Example Embodiment C6, further comprising: transmitting, to the IAB node, a resource configuration of the IAB-DU cell, wherein the resource configuration comprises at least one of a TDM resource configuration and a FDM resource configuration.

Example Embodiment C8. The method of any one of Example Embodiments C6 to C7, further comprising transmitting, to the IAB node, a table of time-domain and frequency-domain availability combinations for the IAB-DU cell.

Example Embodiment C9. The method of any one of Example Embodiments C1 to C8, wherein the IAB node is configured with a first AI-RNTI for the time-domain resource and a second AI-RNTI for the frequency-domain resource.

Example Embodiment C10. The method of any one of Example Embodiments C1 to C9, further comprising configuring the IAB node to identify an availability for the time-domain resource and/or the frequency-domain resource for an IAB-DU cell.

Example Embodiment C11. The method of any one of Example Embodiments C1 to C10,further comprising configuring the IAB node to derive at least one of a time-domain AvailabilityCombinationID and/or frequency-domain AvailabilityCombinationID for an IAB-DU cell.

Example Embodiment C12. The method of Example Emboidment C11, further comprising configuring the IAB node to identify at least one of a time domain resourceAvailability sequence and/or a frequency-domain resourceAvailability sequence based on a respective one of the time-domain AvailabilityCombinationID and the frequency-domain AvailabilityCombinationID.

Example Emboidment C13. The method of any one of Example Embodiments C1 to C12, further comprising configuring the IAB node to identify at least one of a time-domain Al index and/or a frequency-domain AI index.

Example Emboidment C14. The method of any one of Example Embodiments C1 to C13, further comprising configuring the IAB node to identify a time-domain AvailabilityCombinationID and/or a frequency-domain AvailabilityCombinationID.

Example Emboidment C15. The method of any one of Example Embodiments C1 to C14, further comprising configuring the IAB node to identify a time-domain resourceAvailability sequence and/or a frequency-domain resource Availability sequence.

Example Emboidment C16. The method of any one of Example Embodiments C1 to C15, further comprising configuring the IAB node to identify a time-domain resource Availability value and/or a frequency-domain resource Availability value.

Example Embodiment C17. The method of Example Embodiment C16, wherein the time-domain resourceAvailability value and/or the frequency-domain resourceAvailability value is based on a TDM soft resource and/or a frequency soft resource, respectively.

Example Embodiment C18. The method of any one of Example Embodiments C1 to C17, wherein any of the steps of the preceding Example Embodiments are performed and/or repeated on a slot-by-slot basis.

Example Embodiment C19. The method of any one of Example Embodiments C1 to C18, wherein any of the steps of the preceding Example Embodiments are performed and/or repeated on a resource block set by resource block set basis.

Example Embodiment C20. The method of any of the previous Example Embodiments, further comprising: obtaining user data; and forwarding the user data to a host or a user equipment.

Example Embodiment C21. A network node comprising processing circuitry configured to perform any of the methods of Example Embodiments C1 to C20.

Example Embodiment C22. A computer program comprising instructions which when executed on a computer perform any of the methods of Example Embodiments C1 to C20.

Example Embodiment C23. A computer program product comprising computer program, the computer program comprising instructions which when executed on a computer perform any of the methods of Example Embodiments C1 to C20.

Example Embodiment C24. A non-transitory computer readable medium storing instructions which when executed by a computer perform any of the methods of Example Embodiments C1 to C20.

### Group D Example Embodiments

Example Embodiment D1. A method by a IAB node, the method comprising: receiving information indicating an availability indication (AI) for a time-domain resource; and receiving information indicating an AI for a frequency-domain resource.

Example Emboidment D2a. The method of Example Emboidment D1, wherein the information indicating the AI for the time-resource is received in a first message, and the information indicating the AI for the time-resource is received in a second message.

Example Embodiment D2b. The method of Example Embodiment D2a, wherein at least one of the first message and the second message are DCI format 2_5.

Example Embodiment D2c. The method of any one of Example Embodiments D2a to D2b, wherein the first message and the second message are received at/in different downlink slots.

Example Embodiment D2d. The method of any one of Example Embodiments D2a to D2c, further comprising monitoring even slots for the first message and monitoring odd slots for the second message.

Example Embodiment D2e. The method of any one of Example Embodiments D2a to D2c, further comprising monitoring odd slots for the first message and monitoring even slots for the second message.

Example Embodiment D3a. The method of Example Emboidment C1, wherein the information indicating the AI for the time-resource and the information indicating the AI for the time-resource is transmitted in a single message.

Example Embodiment D3b. The method of any one of Example Embodiments D1 to D3a, wherein the information is received from a network node that is operating as a parent node to the IAB node.

Example Embodiment D4. The method of any one of Example Embodiments D1 to D3b, wherein at least one of the time-domain resource and the frequency-domain resource is a soft resource.

Example Embodiment D5a. The method Example Embodiment D4, further comprising: at a slot, applying the time-domain resource and/or the frequency-domain resource.

Example Embodiment D5b. The method of any one of Example Embodiments D4 to D5a, further comprising inspecting the slot to determine that the slot is the configured as a soft resource and/or soft resource slot.

Example embodiment D5c. The method of Example Embodiment D5b, further comprising: when the slot is configured as a time-domain soft resource, reading a resourceAvailability value from a TDM resourceAvailability sequence of one or more TDM availability combinations.

Example embodiment D5d. The method of Example Embodiment D5b, further comprising: when the slot is configured as a frequency-domain soft resource, reading a resourceAvailability value from a FDM resourceAvailability sequence of one or more FDM availability combinations.

Example embodiment D5e. The method of any one of Example Embodiments D5a to D5d, further comprising: repeating any of the steps of Example Embodiments D5a to D5d for at least one subsequent slot.

Example Embodiment D6. The method of any one of Example Embodiments D1 to D5, further comprising transmitting, to a network node, capability information indicating a resource multiplexing capability of IAB-DU cell.

Example Embodiment D7. The method of Example Embodiment D6, further comprising: receiving, from a network node, a resource configuration of the IAB-DU cell, wherein the resource configuration comprises at least one of a TDM resource configuration and a FDM resource configuration.

Example Embodiment D8. The method of any one of Example Embodiments D6 to D7, further comprising receiving, from a network node, a table of time-domain and frequency-domain availability combinations for the IAB-DU cell.

Example Embodiment D9. The method of any one of Example Embodiments D1 to D8, wherein the IAB node is configured with a first AI-RNTI for the time-domain resource and a second AI-RNTI for the frequency-domain resource.

Example Embodiment D10. The method of any one of Example Embodiments D1 to D9, further comprising identifying an availability for the time-domain resource and/or the frequency-domain resource for an IAB-DU cell.

Example Embodiment D11. The method of any one of Example Embodiments D1 to D10, further comprising deriving at least one of a time-domain AvailabilityCombinationID and/or frequency-domain AvailabilityCombinationID for an IAB-DU cell.

Example Embodiment D12. The method of Example Emboidment D11, further comprising identifying at least one of a time domain resourceAvailability sequence and/or a frequency-domain resourceAvailability sequence based on a respective one of the time-domain AvailabilityCombinationID and the frequency-domain AvailabilityCombinationID.

Example Emboidment D13. The method of any one of Example Embodiments D1 to D12, further comprising identifying at least one of a time-domain AI index and/or a frequency-domain AI index.

Example Emboidment D14. The method of any one of Example Embodiments D1 to D13, further comprising identifying a time-domain AvailabilityCombinationID and/or a frequency-domain AvailabilityCombinationID.

Example Emboidment D15. The method of any one of Example Embodiments D1 to D14, further comprising identifying a time-domain resourceAvailability sequence and/or a frequency-domain resourceAvailability sequence.

Example Emboidment D16. The method of any one of Example Embodiments D1 to D15, further comprising identifying a time-domain resourceAvailability value and/or a frequency-domain resource Availability value.

Example Embodiment D17. The method of Example Embodiment D16, wherein the time-domain resourceAvailability value and/or the frequency-domain resourceAvailability value is based on a TDM soft resource and/or a frequency soft resource, respectively.

Example Embodiment D18. The method of any one of Example Embodiments D1 to D17, wherein any of the steps of the preceding Example Embodiments are performed and/or repeated on a slot-by-slot basis.

Example Embodiment D19. The method of any one of Example Embodiments D1 to D18, wherein any of the steps of the preceding Example Embodiments are performed and/or repeated on a resource block set by resource block set basis.

Example Embodiment D20. The method of any of the previous Example Embodiments, further comprising: obtaining user data; and forwarding the user data to a host or a user equipment.

Example Embodiment D21. A network node comprising processing circuitry configured to perform any of the methods of Example Embodiments D1 to D20.

Example Embodiment D22. A computer program comprising instructions which when executed on a computer perform any of the methods of Example Embodiments D1 to D20.

Example Embodiment D23. A computer program product comprising computer program, the computer program comprising instructions which when executed on a computer perform any of the methods of Example Embodiments D1 to D20.

Example Embodiment D24. A non-transitory computer readable medium storing instructions which when executed by a computer perform any of the methods of Example Embodiments D1 to D20.

### Group E Example Embodiments

Example Embodiment E1. A user equipment comprising: processing circuitry configured to perform any of the steps of any of the Group A and C Example Embodiments; and power supply circuitry configured to supply power to the processing circuitry.

Example Embodiment E2. A network node comprising: processing circuitry configured to perform any of the steps of any of the Group B and D Example Embodiments; power supply circuitry configured to supply power to the processing circuitry.

Example Embodiment E3. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Emboidment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Emboidment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Emboidment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Emboidment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

1.-14. (canceled)

15. A method by an Integrated and Access Backhaul (IAB) node, the method comprising:
receiving, from a parent IAB node, information indicating an availability indication, AI, for a time-domain multiplexing, TDM, resource configuration for an IAB-Distributed Unit, IAB-DU, cell associated with the IAB node; and
receiving, from the parent IAB node, information indicating an AI for a frequency-domain multiplexing, FDM, resource configuration for the IAB-DU cell.

16. The method of claim 15, wherein:
the information indicating the AI for the TDM resource configuration is received in a first message, and
the information indicating the AI for the FDM resource configuration is received in a second message.

17. The method of claim 16, wherein at least one of the first message and the second message are DCI format 2_5.

18. The method of claim 16, wherein the first message is received in a first downlink slot and the second message is received in a second downlink slot.

19. The method of claim 15, comprising monitoring a first set of slots for the first message and monitoring a second set of slots for the second message.

20. The method of claim 15, wherein the information indicating the AI for the TDM resource configuration and the information indicating the AI for the FDM resource configuration is received in a single message.

21. The method of claim 15, wherein at least one resource associated with the TDM resource configuration or the FDM resource configuration is a soft resource.

22. The method claim 21, comprising applying, at a slot, the TDM resource configuration or the FDM resource configuration to at the at least one resource.

23. The method of claim 15, comprising receiving, from a donor-Centralized Unit, donor-CU, a resource configuration of the IAB-DU cell, wherein the resource configuration comprises at least one of the TDM resource configuration and the FDM resource configuration.

24. The method of claim 23, comprising receiving, from the donor-Centralized Unit, donor-CU, configuration information associated with a sequence of slots, wherein the configuration information indicates whether each one of the sequence of slots is a hard resource, a soft resource, or a not available resource.

25. The method of claim 24, comprising:
when a particular slot is configured as a TDM soft resource, reading a resourceAvailability value from a TDM resourceAvailability sequence of one or more TDM availability combinations, and/or
when the particular slot is configured as a FDM soft resource, reading a resourceAvailability value from a FDM resourceAvailability sequence of one or more FDM availability combinations.

26. The method of claim 15, comprising transmitting, to the parent IAB node, capability information indicating a resource multiplexing capability of the IAB node for the IAB-DU cell.

27. The method of claim 15, comprising receiving, from the parent IAB node, at least one availabilityCombinations table, the at least one availability Combinations table comprising:
at least one TDM availability combination for the IAB-DU cell; and/or
at least one FDM availability combination for the IAB-DU cell.

28. The method of claim 15, wherein the AI for the TDM resource configuration comprises a first AI-RNTI and the AI for the FDM resource configuration comprises a second AI-RNTI.

29. The method of claim 15, comprising identifying an availability for the TDM resource configuration and/or the FDM resource configuration for the IAB-DU cell.

30. The method of claim 15, comprising deriving at least one of a TDM AvailabilityCombinationID and/or FDM Availability CombinationID for the IAB-DU cell.

31. The method of claim 30, further comprising identifying at least one of a TDM resourceAvailability sequence and/or a FDM resourceAvailability sequence based on a respective one of the TDM AvailabilityCombinationID and the FDM Availability CombinationID.

32. The method of claim 15, further comprising identifying at least one of a TDM AI index and/or a FDM AI index.

33. The method of claim 15, comprising identifying a TDM resourceAvailability value and/or a FDM resourceAvailability value, and wherein the TDM resourceAvailability value and/or the FDM resourceAvailability value is based on FDM soft resource.

34.-35. (canceled)

36. An Integrated and Access Backhaul, IAB, node comprising processing circuitry configured to:
receive, from a parent IAB node, information indicating an availability indication, AI, for a time-domain multiplexing, TDM, resource configuration for an IAB-Distributed Unit, IAB-DU, cell associated with the IAB node; and
receive, from the parent IAB node, information indicating an AI for a frequency-domain multiplexing, FDM, resource configuration for the IAB-DU cell.

37. (canceled)
